(19) United States
(12) Patent Application Publication
(10) Pub. No.: US 2016/0379360 A1
(43) Pub. Date: Dec. 29, 2016

(54) INSPECTING METHOD, INSPECTING APPARATUS, IMAGE PROCESSING APPARATUS, PROGRAM AND RECORDING MEDIUM

(71) Applicant: CANON KABUSHIKI KAISHA, Tokyo (JP)

(72) Inventor: Tetsuzo Ito, Yokohama-shi (JP)

(21) Appl. No.: 15/185,534

(22) Filed: Jun. 17, 2016

(30) Foreign Application Priority Data
Jun. 26, 2015 (JP) 2015-128700

(51) Int. Cl. G06T 7/00; G06T 5/00

(52) U.S. Cl. CPC G06T 7/0008; G06T 5/006; G06T 7/0083; G06T 2207/10028; G06T 2207/30164; G06T 2207/10152

(57) ABSTRACT

A three-dimensional model corresponding to a work and a virtual surface corresponding to an imaging device are specified. The model is projected onto the virtual surface, to calculate boundary pixels constituting an outline of a projected region. A coordinate position of the boundary pixel is converted, according to a distortion adding table including a plural table elements each associated to a coordinate position of the pixel at a start point of moving, with a moving distance of the pixel at the start point of moving regarding a destination of moving. An inside surrounded by boundary pixels of the coordinate positions converted is set as an inspection region. The inside of the inspection region in the image is inspected. The plural table elements include a first table element associating to one moving distance with one coordinate position. A second table element associated to plural moving distances with one coordinate position.

### BACKGROUND OF THE INVENTION

Field of the Invention

The present invention relates to an inspecting method for inspecting a work, an inspecting apparatus, an image processing apparatus, a program and a recording medium.

Description of the Related Art

In a field of a visual external inspection, the inspection has been progressively shifted from a visual inspection by human to an inspection by a machine. A technology of handling three-dimensional data and an image processing technology have become currently prevalent due to the enhancement of calculation capability of a computer and reduction thereof in the price, and accordingly the development of a general-purpose inspecting apparatus has started which does not depend on the shape of a work that is an object to be inspected.

For instance, referring to National Publication of International Patent Application No. 2007-527993, in case of inputting three-dimensional CAD data of an object to be inspected, the inspection path and the inspection region can be automatically set. A work which has only a defect type that has an easy shape and is not difficult to be visualized can be inspected with the use of the above described technology.

However, there exists such an object to be inspected that all of the defects cannot be visualized unless the work is photographed on a large number of imaging conditions while the position (which also includes orientation) of the work is variously changed. The object to be inspected is, for instance, an appearance inspection of a small-sized product which has a complicated shape and a defect has that has directivity with respect to illumination light, and the like. In the case of such a work, the work can be continuously imaged while the illumination and the camera are fixed, and the position of the work is changed, and thereby can be inspected.

When the work is imaged while being moved, it is necessary to specify what place on the photographed image should be set as an object to be inspected. As for how the work having a three-dimensional shape is viewed by a camera, there is a method of calculating the three-dimensional shape by using a camera parameter and regarding a camera as a pinhole model, as in an example of Japanese patent No. 3516118.

If this technology is used, it can be calculated what place on the photographed image should be set as the object to be inspected, from the position of the work and the pinhole model of the imaging camera, but the image which has been photographed through an actual imaging lens causes distortion that is referred to as distortion aberration. Accordingly, the lens distortion must be coped with.

There exist many techniques of eliminating the distortion of the imaging lens from the picked-up image, and Japanese patent No. 4906753 proposes a method of preparing a correction table for the distortion of the lens, and calculating the lens distortion with the use of the correction table.

In the visual external inspection of the work, it is very important which region in the picked-up image is measured, and it is necessary to strictly manage a boundary inside and outside of a range to be inspected. If the region of the range to be inspected deviates, the result gives a serious influence such as erroneous detection and excessive detection, on an inspecting machine. In addition, when the work is largely moved, a portion in the periphery of a lens, in which the distortion is large, is also used for the inspection, and accordingly the lens distortion must be taken into consideration by all means.

As a countermeasure method against the lens distortion, two countermeasures are considered which are a countermeasure of inspecting the work by using an image obtained by eliminating the lens distortion from the picked-up image, and a countermeasure of adding the lens distortion to a calculated inspection region (comparison image), and inspecting the work. The inspecting apparatus to be used in a production site is required to have a short inspection tact time, and accordingly it is better to give the lens distortion to the inspection region, because a calculation load in the method of adding the distortion only to the calculated inspection region is smaller than that in the method of eliminating the distortion of the whole image from the image obtained by imaging.

In addition, the image in the inspection region can be defined by a binarized image which has been subjected to binarization processing, and accordingly the calculation load in the method of adding and calculating the lens distortion only to the boundary pixels which constitute the outline of the inspection region can be more reduced than that in the method of performing the distortion adding calculation on all pixels in the inspection region. The method may be a process of adding the distortion to the boundary pixels, then setting the inside thereof at the same value as that of the boundary pixel, and determining the calculated region as the inspection region.

The lens distortion may be added by using a camera parameter, similarly to the elimination of the lens distortion. In addition, the method of performing the distortion adding calculation by using the correction table in which the distortion moving distance is recorded can be performed at a higher speed than the method of calculating the moving distance of each of the pixels one by one.

However, the pixel position of a digital image is determined by an integer value, and accordingly when a distortion adding table of an integer type is used, a boundary line of the inspection region occasionally results in being broken. When the boundary line is broken, the inspection region to be structured by a closed space does not become the closed space, and the inspecting apparatus results in being incapable of performing an operation of setting the inspection region at the same value as the boundary pixel (so-called filling operation).

It is possible to cope with the breaking of the boundary line by connecting the broken part by expansion contracting processing or interpolation processing, but the calculation time period becomes long instead. It has been required that the inspecting apparatus adds the lens distortion to the image in the inspection region, without performing the expansion contracting processing and the interpolation processing and without breaking the boundary line of the inspection region.

Then, an object of an aspect of the present invention is to calculate the inspection region of the picked-up image of the work, at high speed.

### SUMMARY OF THE INVENTION

According to an aspect of the present invention, an inspecting method in which a camera has an imaging device and an imaging lens, and a processing unit makes the camera pick up an image of a work and inspects the work based on the obtained image, comprises: pixel calculating in which the processing unit specifies a three-dimensional model that corresponds to the work and a virtual surface that corresponds to the imaging device, projects the three-dimensional model in the same relative position as a relative position of the work at the time when the image has been picked up by the camera, onto the virtual surface, and calculates boundary pixels which constitute an outline of the projected region; converting in which the processing unit converts a coordinate position of the boundary pixel, according to a distortion adding table that has a plurality of table elements each of which associates the coordinate position of the pixel at a start point of moving, with a moving distance of the pixel at the start point of moving with respect to a destination of moving, and adds distortion caused by the imaging lens to an object image; setting in which the processing unit sets an inside surrounded by the boundary pixels of which the coordinate positions have been each converted in the converting, as an inspection region; and inspecting in which the processing unit inspects the inside of the inspection region in the image, wherein a plurality of table elements of the distortion adding table includes a first table element which associates one moving distance with one coordinate position so that a pixel at a start point of moving moves to one coordinate position, and a second table element which associates a plurality of moving distances with one coordinate position so that a pixel at the start point of moving dispersedly moves to a plurality of coordinate positions.

The inspecting apparatus according to an aspect of the present invention can calculate the inspection region for the picked-up image of the work, at high speed.

Further features of the present invention will become apparent from the following description of exemplary embodiments with reference to the attached drawings.

### BRIEF DESCRIPTION OF THE DRAWINGS

FIG. 1 is a schematic view illustrating an inspecting apparatus according to an embodiment.

FIG. 2 is a block diagram illustrating an image processing apparatus according to the embodiment.

FIG. 3 is a flow chart illustrating an inspecting method according to the embodiment.

FIG. 4 is a schematic view in which an imaging system in FIG. 1 is illustrated by a pinhole model.

FIG. 5A is a schematic view illustrating an example in which an inspection object surface is perspectively projected onto a virtual surface, in the case where a three-dimensional model is positioned in the center with respect to the virtual surface. FIG. 5B is a schematic view illustrating an example in which the inspection object surface is perspectively projected onto the virtual surface, in the case where the three-dimensional model is shifted to right with respect to the virtual surface, by translational movement. FIG. 5C is a schematic view illustrating an example in which the inspection object surface is perspectively projected onto the virtual surface, in the case where the three-dimensional model has been rotated with respect to the virtual surface.

FIG. 6A is a schematic view illustrating a distortion of an image which has been picked up by a camera. FIG. 6B is an explanatory view that compares an image which has been calculated according to the pinhole model, with an image to which the distortion caused by the imaging lens has been added.

FIG. 7 is a flow chart illustrating calculation processing on an inspection region, according to the embodiment.

FIG. 8 is an explanatory view illustrating one example of the calculation processing on the inspection region, according to the embodiment.

FIG. 9 is an explanatory view illustrating the case where an image is corrected with the use of an LUT according to the embodiment.

FIG. 10 is a flow chart illustrating table forming processing for forming a distortion adding table.

FIG. 11 is an explanatory view illustrating the table forming processing for forming the distortion adding table.

FIG. 12 is an explanatory view illustrating a scanning method for a noticed pixel.

FIG. 13 is an explanatory view illustrating an example of the case where an image is corrected with the use of an LUT according to a comparative example.

FIG. 14 is an explanatory view illustrating an example of the case where the image is corrected with the use of the LUT according to the comparative example.

### DESCRIPTION OF THE EMBODIMENTS

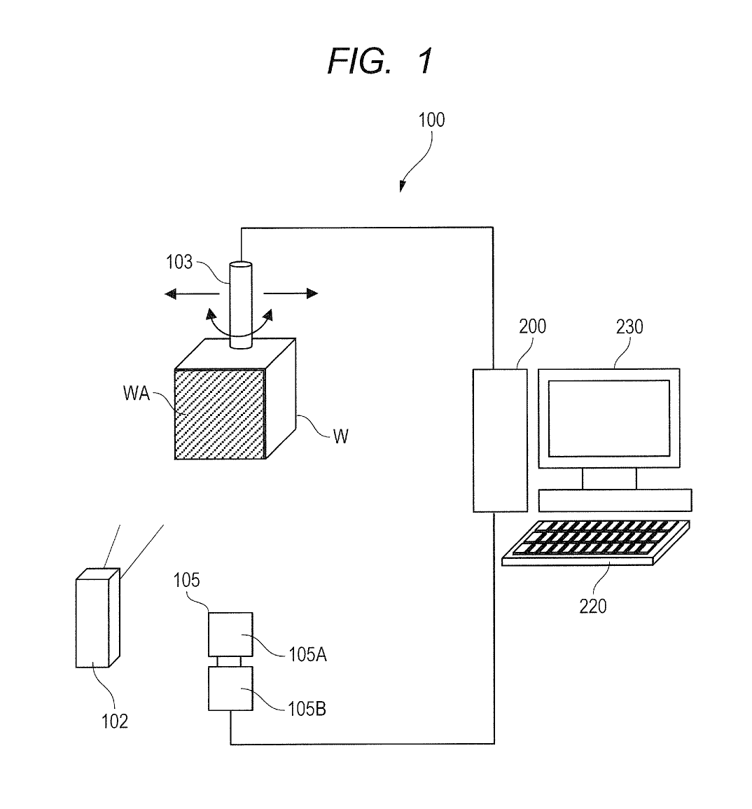

Embodiments for carrying out the present invention will be described below in detail with reference to the drawings. FIG. 1 is a schematic view illustrating an inspecting apparatus according to an embodiment of the present invention. The inspecting apparatus 100 includes: a light source 102 which irradiates a work (inspection object article) W with light; a moving apparatus 103 which moves the work W; a camera 105 which acts as an imaging apparatus; and an image processing apparatus 200 which is also a controlling apparatus.

In the present embodiment, the work W is an optical component. The inspecting apparatus 100 performs a visual external inspection for detecting a defect such as a flaw, dirt and a contaminant on a surface WA of the work W. Incidentally, the work W may be a component other than the optical component, and may be an exterior component of a camera, for instance. The work W means articles which include all of the components that are manufactured in a factory.

The light source 102 is an illumination apparatus which irradiates (illuminates) the work W with light. The light source 102 may be any light source as long as the light source irradiates the work W with light having a light quantity necessary for image processing, for instance, such as an LED and a halogen lamp, and may also be any illumination such as ring illumination and bar illumination. In addition, a diffuser panel, a lens and the like may be arranged on a light-emitting surface side of the light source 102.

The camera 105 is a digital camera which receives light from the work W and forms data of a picked-up image. The camera 105 has an imaging lens 105A, and an imaging device (solid imaging device) 105B.

The imaging device 105B is an area sensor such as a CMOS image sensor and a CCD image sensor. The imaging lens 105A is an objective lens unit which adjusts magnification, and adjusts the magnification so that the whole work W is imaged on an imaging device 105B.

The moving apparatus 103 relatively linearly or rotationally moves the work W with respect to the camera 105 and the light source 102.

The image processing apparatus 200 subjects the picked-up image which has been imaged by the camera 105 to image processing, and detects the defect existing in the work W. Then, the image processing apparatus 200 determines whether the work W is OK or NG. In addition, the image processing apparatus 200 controls imaging such as imaging timing by the camera 105, and controls the operation of the moving apparatus 103, in other words, the position and the orientation of the work W; and acquires the data of the position and the orientation of the work W at this time.

A keyboard 220 which acts as an input device and a monitor 230 which acts as a display device are connected to the image processing apparatus 200. On the monitor 230, for instance, an image processing result and a determination result of OK or NG according to the image processing apparatus 200 are displayed.

In the present embodiment, the camera 105 and the light source 102 are fixed to the trestle and other structures, and the relative position between the camera 105 and the light source 102 is fixed. In addition, the relative position between the work W with respect to the camera 105 and the light source 102 changes. Specifically, the moving apparatus 103 can change the relative position of the camera 105 and the light source 102 with respect to the work W, by moving the work W. Incidentally, the case will be described below in which the moving apparatus 103 moves the work W, but the moving method is not limited to the method of moving the work W. The light source 102 (camera 105) may be moved with respect to the work W, and the work W and the light source 102 (camera 105) may be moved. In other words, the moving apparatus may be an apparatus which changes a relative position of at least one of the light source 102 and the camera 105, with respect to the work W.

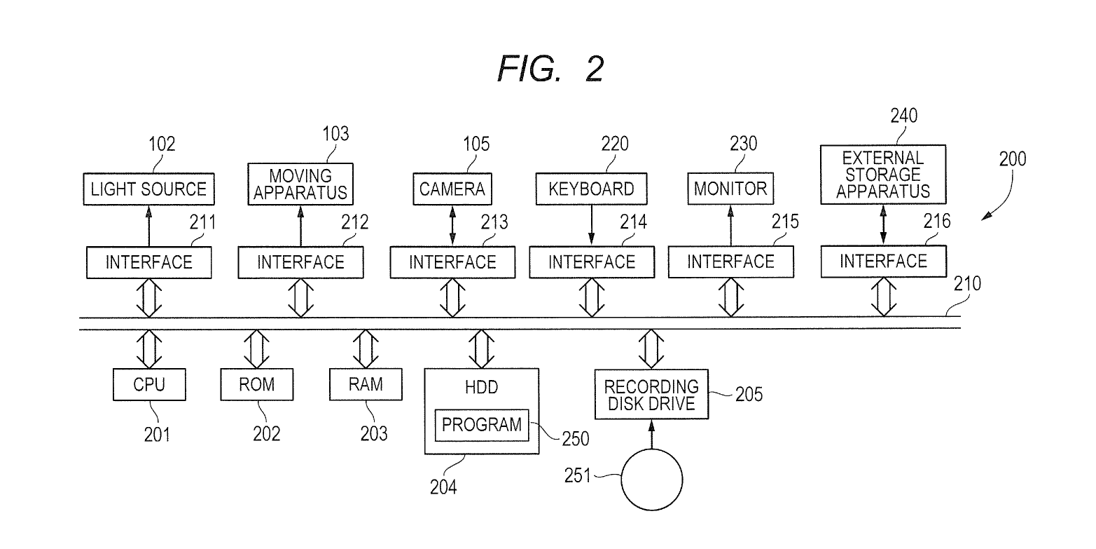

FIG. 2 is a block diagram illustrating an image processing apparatus according to the embodiment of the present invention. The image processing apparatus 200 has a CPU (Central Processing Unit) 201 which acts as a processing unit (arithmetic logical unit). In addition, the image processing apparatus 200 also has a ROM (Read Only Memory) 202, a RAM (Random Access Memory) 203 and a HDD (Hard Disk Drive) 204, which act as storage units. In addition, the image processing apparatus 200 also has: a recording disk drive 205; and various types of interfaces 211 to 216.

The ROM 202, the RAM 203, the HDD 204, the recording disk drive 205 and various types of the interfaces 211 to 216 are connected to the CPU 201 through a bus 210. The ROM 202 stores a basic program such as a BIOS therein. The RAM 203 is a storage apparatus which temporarily stores various data such as an arithmetic processing result of the CPU 201 therein.

The HDD 204 is a storage apparatus which stores the arithmetic processing result of the CPU 201, various data that have been acquired from the outside, and the like therein, and also records a program 250 therein for making the CPU 201 execute various arithmetic processing which will be described later. The CPU 201 executes each process in the inspecting method, based on the program 250 which is recorded (stored) in the HDD 204.

The recording disk drive 205 can read out various data, a program and the like which are recorded in a recording disk 251.

The light source 102 is connected to the interface 211, and is turned on or turned off under the control of the CPU 201. The moving apparatus 103 is connected to the interface 212, and moves the work W (in the present embodiment, linearly or rotationally moves) under the control of the CPU 201.

The camera 105 is connected to the interface 213, picks up the image in response to a trigger signal sent from the CPU 201, and outputs the data of the picked-up image which is an image pickup result, to the CPU 201. The CPU 201 acquires the data of the picked-up image from the camera 105, subjects the picked-up image to the image processing, and detects a defect such as the flaw and dirt of the work W.

The keyboard 220 is connected to the interface 214, and outputs an operation result of a user to the CPU 201. The monitor 230 is connected to the interface 215, and displays an image under the control of the CPU 201. In addition, an external storage apparatus 240 such as a rewritable nonvolatile memory and an external HDD can be connected to the interface 216.

Incidentally, in the present embodiment, the case will be described below in which a recording medium that can be read by a computer is the HDD 204, and the program 250 is stored in the HDD 204, but the case is not limited to the above case. The program 250 may be recorded in any recording medium as long as the recording medium can be read by the computer. For instance, the ROM 202, the recording disk 251 and the external storage apparatus 240 which are illustrated in FIG. 2, and the like, may be used as the recording medium for supplying the program 250. Specific usable examples of the recording medium include a flexible disk, a hard disk, an optical disk, a magneto-optical disk, a CD-ROM, a CD-R, a magnetic tape, a nonvolatile memory and a ROM.

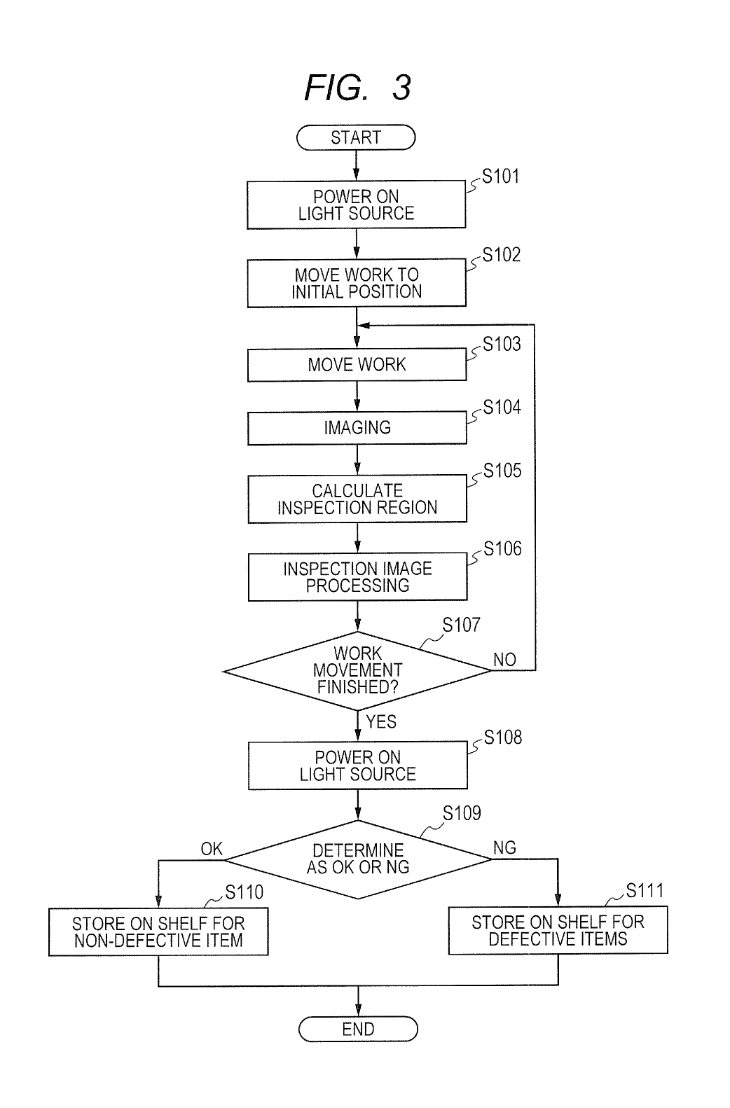

Next, the inspecting method according to the present embodiment will be described. FIG. 3 is a flow chart illustrating the inspecting method according to the embodiment of the present embodiment. In the present embodiment, the CPU 201 executes each process (each processing) of the inspecting method, which is illustrated in FIG. 3, according to the program 250. Here, the work W shall be fixed to the moving apparatus 103.

Firstly, the CPU 201 turns a light source 102 on (S101), and makes the moving apparatus 103 move the work W to an initial position (which includes orientation) (S102).

Next, the CPU 201 operates the moving apparatus 103 to make the moving apparatus 103 move the work W, in other words, change the position (which includes orientation) of the work W (S103). Here, the operation of the moving apparatus 103 is previously set in the image processing apparatus 200 (specifically, in HDD 204 which acts as storage unit, or the like). By operating the moving apparatus 103 according the operation data, the CPU 201 can change the position of the work W with respect to the light source 102 and the camera 105.

Next, the CPU 201 makes the camera 105 pick up an image of the work W, and acquires the image from the camera 105 (S104). At this time, the CPU 201 subjects the image which has been acquired from the camera 105 to binarization processing, and acquires an image (binarized image) which has been subjected to the binarization processing (image acquiring process and image acquiring processing).

The focus of the imaging lens 105A is set at the work W, and the camera 105 takes in the scattered light of a defect such as the contamination, the flaw and the dirt in the work W, onto the imaging device 105B, as image data. The image which has been photoelectrically converted by the imaging device 101A is converted into a digital image signal by an unillustrated A/D converter, and is output to the CPU 201. In addition, the CPU 201 acquires the orientation information of the moving apparatus 103 in a three-dimensional space from the moving apparatus 103 at imaging, and determines data (information on position) of the position (which includes orientation) of the work W.

Then, the CPU 201 calculates the inspection region which shows what place in the photographed image should be set at an object to be inspected, from the position (which includes orientation) in the three-dimensional space of the inspection object surface WA of the work W, and the camera parameter of the camera 105 (S105).

The CPU 201 performs the image processing by using the data of the image and the calculated inspection region, and stores the resultant image as an image for inspection (S106). Specifically, the CPU 201 extracts only the inspection region in the image which has been subjected to the binarization processing, and stores the extracted inspection region as the image for inspection in the HDD 204 or the like.

Next, the CPU 201 determines whether or not the CPU 201 has performed all of the changes of the positions (which include orientation), which have been scheduled for the work W (S107).

If the CPU 201 has not performed all of the changes of the positions (S107: No), the CPU 201 returns to the step S103, and continues the change of the position, imaging and image processing. Thereby, the CPU 201 acquires a plurality of images of which the positions of the works W are different from each other, and results in forming a plurality of inspection regions which correspond to the plurality of images, respectively. If all of the changes of the positions have ended (S107: Yes), the CPU 201 turns off the light source 102 (S108).

Next, the CPU 201 inspects the work W based on the image for inspection, which the CPU 201 has acquired in the step S106 (S109: inspection process and inspection processing). Specifically, the CPU 201 inspects the image for inspection, which has been acquired in the step S106 and is an image extracted from the inside of the inspection region that has been calculated in the step S105. In the present embodiment, the CPU 201 extracts causes of the defect on the inspection object surface WA of the work W from the binarized image in the inspection region, in other words, extracts candidates of the defect, and determines whether the candidates of the defect are defective or not. Then, the CPU 201 scores the defect, and determines whether or not the calculated score is in an acceptable range.

Here, the work W of which the score of the defect is in the acceptable range is represented as a non-defective product, and the work W of which the score of the defect is out of the acceptable range is represented as a defective product. According to the determination of the step S109, if the work W is the non-defective product (S109: OK), the CPU 201 stores the work W on an unillustrated shelf for a non-defective item by using an unillustrated robot or the like (S110). If the work W is the defective product (S109: NG), the CPU 201 stores the work W on an unillustrated shelf for defective items by using an unillustrated robot or the like (S111).

The processing in a step S105 in FIG. 3 will be described in detail below. Firstly, the CPU 201 makes the camera 105 having the imaging lens 105A mounted thereon pick up a plurality of images of a calibration plate including a pattern such as a dot pattern of which the orientations have been variously changed, and calculates a camera parameter of the camera 105, beforehand. This camera parameter is stored in the storage unit such as the HDD 204, beforehand. The CPU 201 creates the pinhole model in imitation of an actual imaging system, by using the measured camera parameter.

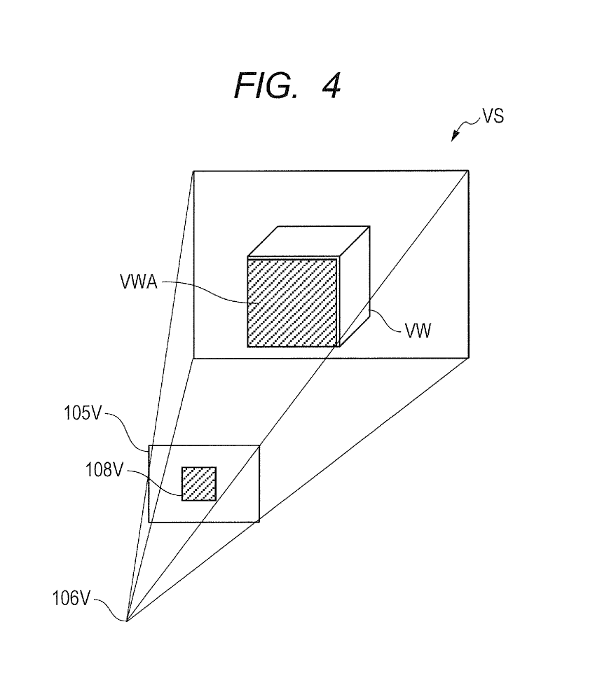

FIG. 4 is a schematic view which shows an imaging system in FIG. 1 in a form of a pinhole model. As is illustrated in FIG. 4, a pinhole 106V, a virtual surface 105V which corresponds to a sensor surface of the imaging device 105B of the camera 105, and a three-dimensional model VW which corresponds to the work W, are arranged in a virtual space VS. The virtual surface 105V is arranged at a position which is distant from the pinhole 106V by a focal length f of the camera parameter. The three-dimensional model VW is, for instance, three-dimensional CAD data.

The CPU 201 determines a region 108V in which the inspection object surface VWA of the three-dimensional model VW is perspectively projected onto the virtual surface 105V. Here, if the coordinate (position orientation) of the inspection object surface WA on the work W can be grasped, the CPU 201 can calculate the position of the inspection object surface WA which comes out on the imaging device 105B (sensor surface) of the camera 105. When the moving apparatus 103 changes the orientation of the work W, the CPU 201 can calculate the orientation at the time after the work W has moved, by sensing the amount of the displacement of the moving apparatus 103.

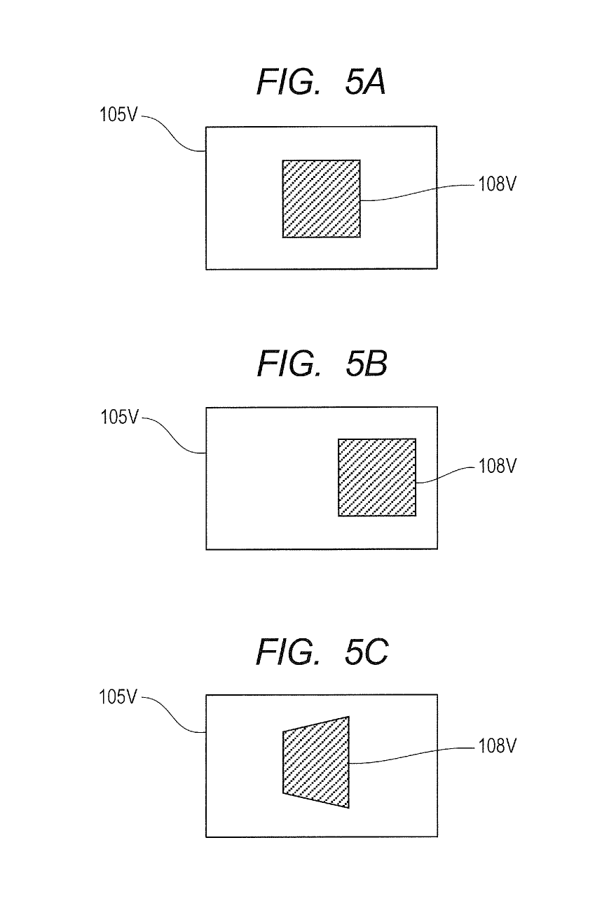

FIG. 5A is a schematic view illustrating an example in which the inspection object surface VWA is perspectively projected onto the virtual surface 105V, in the case where the three-dimensional model VW is positioned in the center with respect to the virtual surface 105V. FIG. 5B is a schematic view illustrating an example in which the inspection object surface VWA is perspectively projected onto the virtual surface 105V, in the case where the three-dimensional model VW has been shifted to right with respect to the virtual surface 105V, by translational movement. FIG. 5C is a schematic view illustrating an example in which the inspection object surface VWA is perspectively projected onto the virtual surface 105V, in the case where the three-dimensional model VW has been rotated with respect to the virtual surface 105V. The region 108V in which the inspection object surface VWA is perspectively projected onto the virtual surface 105V is shifted to right by the translational movement, or is deformed by the rotation.

The perspective projection according to the pinhole model has been described above, but a large difference between the pinhole model and the actual image is that there surely exists such distortion aberration that the image is distorted though depending on the position of the imaging device 105B, in the actual imaging lens 105A, though having a greater or lesser degree.

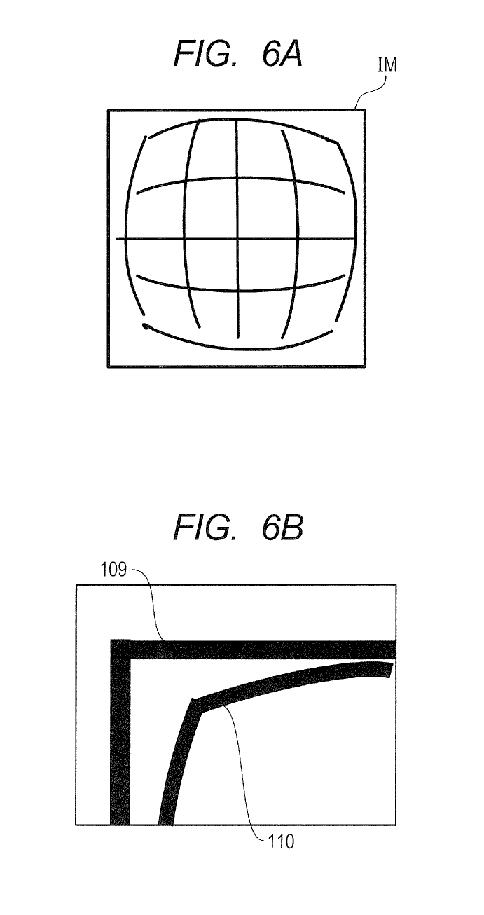

FIG. 6A is a schematic view illustrating distortion in the image which has been picked up by the camera 105. FIG. 6B is an explanatory view that compares an image which has been calculated according to the pinhole model, with an image to which the distortion caused by the imaging lens 105A has been added.

In the case where the imaging lens 105A is a wide angle lens which is often used for inspection, such distortion referred to as barrel-shaped distortion occurs that an image IM shrinks more as the position becomes more distant from the center of the image, as is illustrated in FIG. 6A.

For instance, in the case where the image has been photographed at such a position that the inspection object surface WA comes out on the upper left end of the sensor surface, a boundary line of the inspection region does not form a straight line like a straight line 109 which has been calculated in the pinhole model, and forms a distorted curve like a line 110, as is illustrated in FIG. 6B.

Then, in the present embodiment, the lens distortion is added only to the boundary pixels of the inspection region. After that, the inside of the boundary line is filled, and the resultant image is used as the inspection region.

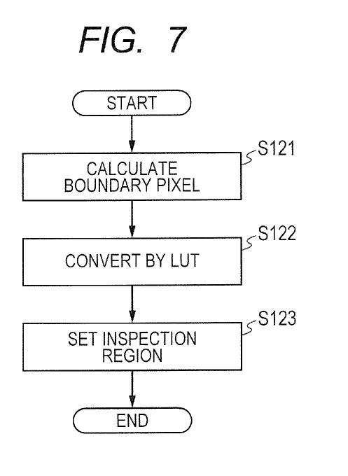

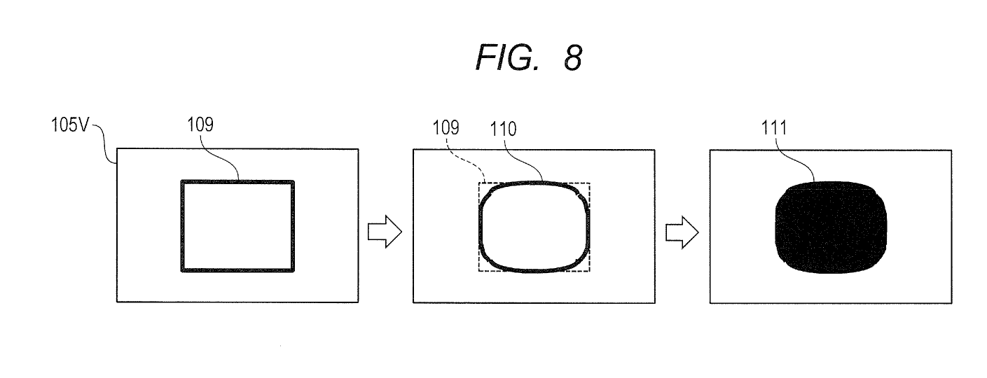

The calculation processing on the inspection region in the step S105 will be described in detail below. FIG. 7 is a flow chart illustrating the calculation processing on the inspection region, according to the embodiment of the present invention. FIG. 8 is an explanatory view illustrating one example of the calculation processing on the inspection region, according to the embodiment of the present invention.

The CPU 201 specifies the three-dimensional model VW which corresponds to the work W, and the virtual surface 105V which corresponds to the imaging device 105B, in the virtual space VS. The CPU 201 projects the three-dimensional model VW in the same relative position as the relative position of the work W at the time when the image has been picked up by the camera 105, onto the virtual surface 105V, and calculates a position of the boundary pixels 109 which constitute the outline of the projected region 108V (S121: pixel calculating process and pixel calculating processing).

The CPU 201 converts the coordinate positions of the boundary pixels 109 according to a distortion adding table (look-up table: LUT) which adds the distortion caused by the imaging lens 105A to the object image, and determines new boundary pixels 110 (S122: converting process and converting processing). Hereafter, the distortion adding table will be referred to as “distortion adding LUT” or “LUT”, except for “distortion adding table”. The distortion adding table is created beforehand, and is stored in the storage unit such as the HDD 204. The distortion adding table will be described in detail later, but has a plurality of table elements each of which associates the coordinate position of the pixel at the start point of moving, with the moving distance of the pixel at the start point of moving with respect to the destination of moving.

The CPU 201 sets the inside surrounded by the boundary pixels 110 of which the coordinate positions have been each converted in the step S122, as the inspection region 111 (S123: setting process and setting processing).

In FIG. 8, the inspection region 111 is formed by the processing of giving the distortion to the boundary pixels (straight boundary line) 109 which have been determined by calculation, thereby forming new boundary pixels 110, and filling the inside of the boundary pixels 110 with the same value (color) as that of the boundary pixel 110.

Before the LUT in the present embodiment will be described, which adds the distortion to the boundary pixels in the processing of the step S122, an LUT in a comparative example will be described below, which adds the distortion to the boundary pixels.

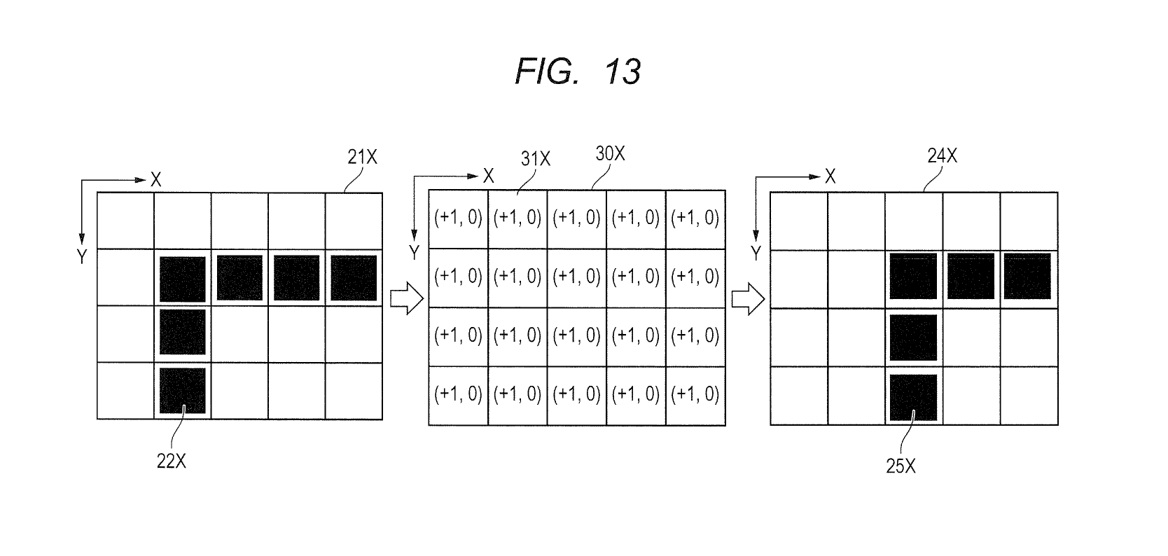

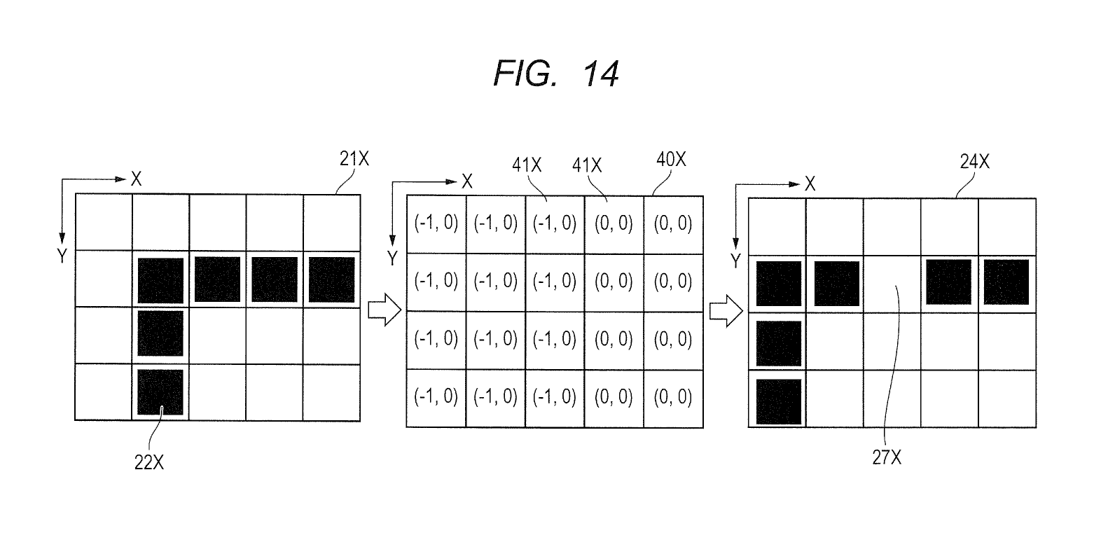

FIG. 13 and FIG. 14 are explanatory views illustrating examples of the case where the image is corrected with the use of the LUT according to the comparative example. An LUT 30X which adds the distortion caused by imaging lens 105A to the image is formed of a plurality of table elements 31X each of which records two moving distances of an X-axis value and a Y-axis value of the corresponding point pixel therein. For instance, in the case where the object image is an image formed of 2048×2048 pixels, the LUT 30X is formed of the table elements 31X of 2048×2048.

In the example of FIG. 13, the moving distance (+1, 0) in the table element 31X which is noticed means that the pixel at the coordinate position is moved by +1 in the X-axis and is moved by 0 in the Y-axis. The lens distortion is given to an image 21X before correction with the use of the distortion adding LUT 30X, and the resultant image becomes an image 24X. In other words, in each of the table elements 31X, the moving distance of the pixel at the start point of moving with respect to the destination of moving is associated with the coordinate position of the pixel at the start point of moving. A boundary line 22X on the original image 21X is moved to a boundary line 25X on the image 24X after correction. Here, the boundary line is formed of a plurality of boundary pixels which are continuously arrayed.

In the calculation of adding the distortion, the moving distance of the pixel does not become an integer but has a decimal fraction, in many cases. If even an extent of a pixel having a decimal point, which is 1 pixel or less, is considered when the lens distortion is added, the calculation speed becomes slow, and accordingly in the case where the high speed is regarded as important, the distortion adding LUT can be held as integer values. The integer type LUT may be created by the processing of rounding or truncating the fractional value of the moving distance. However, in the case where the distortion is added in a form of the integer, when a boundary line of the inspection region lies astride a portion at which the moving distance of the distortion adding LUT changes, a problem arises that the boundary line is broken. For instance, in the distortion adding LUT 40X illustrated in FIG. 14, there is a table element 41X in which the moving distance of the X-axis changes. If the boundary line 22X of the image 21X is input so as to lie astride the table elements 41X, a portion 27X is formed at which the boundary line is broken, in the boundary pixels of the output image 24X after the correction.

Then, in the present embodiment, a one-to-many integer type of distortion adding LUT is used to add the distortion caused by the imaging lens to the boundary pixels, and thereby the distortion is added without breaking the boundary line.

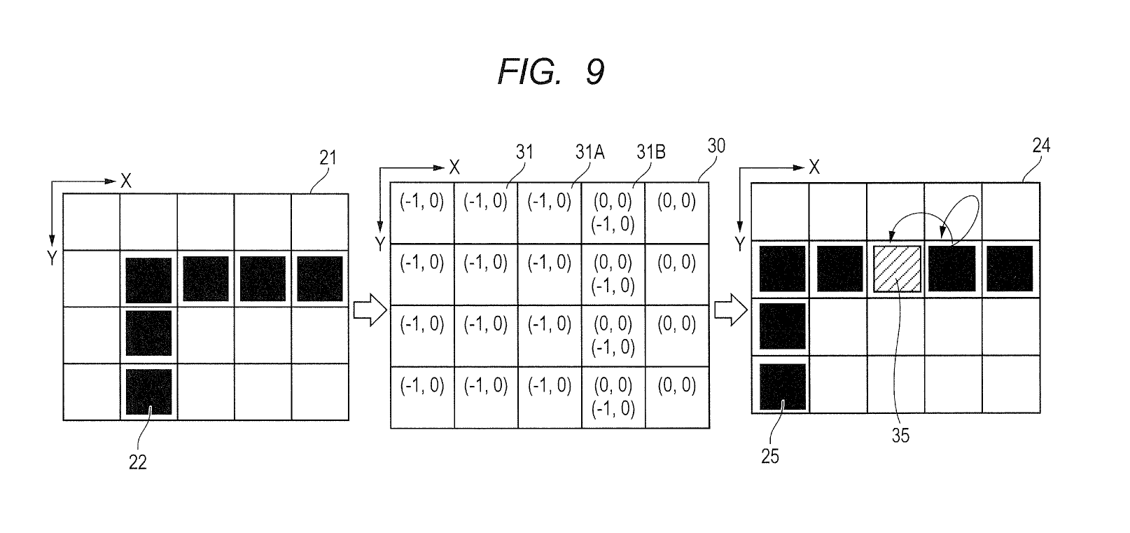

FIG. 9 is an explanatory view illustrating a case where an image is corrected with the use of an LUT according to the embodiment of the present invention. The LUT 30 which shows the distortion adding table illustrated in FIG. 9 has a plurality of table elements 31 each of which associates the coordinate position of the pixel at the start point of moving, with the moving distance of the pixel at the start point of moving with respect to the destination of moving. The LUT 30 is the integer type of LUT.

The plurality of table elements 31 of the LUT 30 each contain a first table element 31A which associates one moving distance with one coordinate position so that the pixel at the start point of moving moves to one coordinate position. The plurality of table elements 31 of the LUT 30 each contains also a second table element 31B which associates the plurality of moving distances with one coordinate position so that the pixel at the start point of moving dispersedly moves to the plurality of coordinate positions. In other words, the LUT 30 includes the first table element 31A and the second table element 31B. The pixel which corresponds to the coordinate position of the first table element 31A moves to one coordinate position according to the first table element 31A. The pixel which corresponds to the coordinate position of the second table element 31B moves to a plurality of coordinate positions according to the second table element 31B.

The CPU 201 moves each of the boundary pixels which constitute the boundary line 22 of the original image 21, by the moving distance according to the LUT 30, and forms a new image 24. In the LUT 30, the coordinate position of the second pixel from the right end in FIG. 9, in other words, the table element 31 which corresponds to the coordinate position (4, 2) is the second table element 31B, and the two moving distances (0, 0) and (−1, 0) are associated with the coordinate position (4, 2). Because of this, the pixel at the coordinate position (4, 2) is dispersedly moved to the coordinate positions (4, 2) and (3, 2) of the plurality of destinations of moving by the second table element 31B, and a plurality of pixels are formed. Accordingly, the pixel is formed also in the portion 35 in which the boundary line is broken in the comparative example illustrated in FIG. 14, and the boundary line 25 which is formed of the plurality of boundary pixels is not broken.

In the present embodiment, the LUT 30 is stored in the storage unit such as the HDD 204 beforehand, and when the CPU 201 executes the step S122 in FIG. 7, the CPU 201 uses the LUT 30 which is stored in the HDD 204.

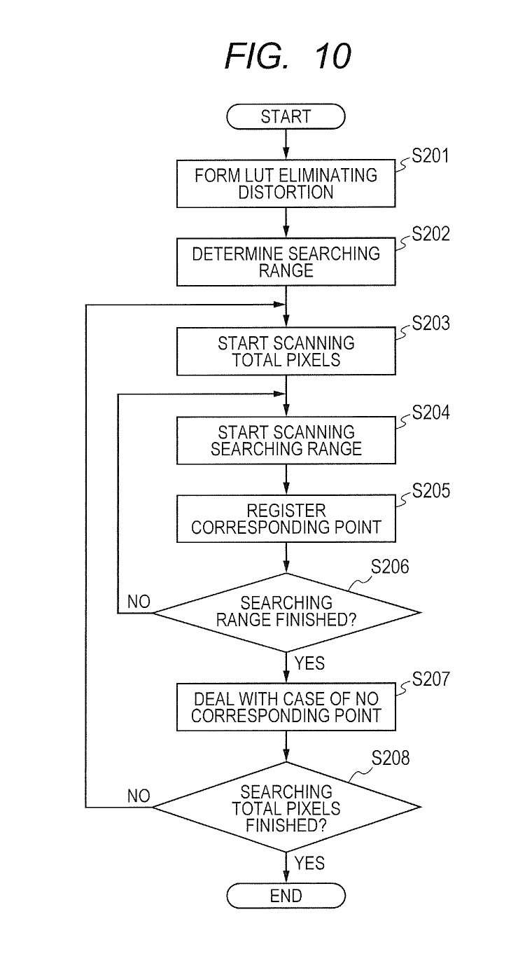

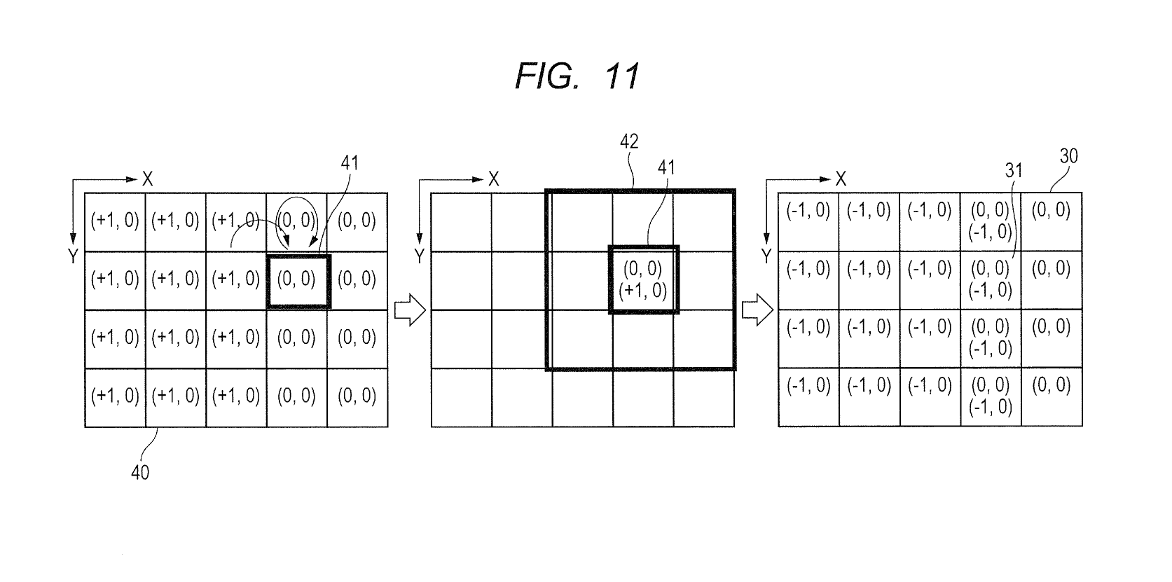

Next, a method for forming the LUT 30 which is used in the step S122 will be described below. FIG. 10 is a flow chart illustrating table forming processing (table forming process) for forming a distortion adding table. FIG. 11 is an explanatory view illustrating the table forming processing (table forming process) for forming the distortion adding table. In the present embodiment, the case where the CPU 201 in the image processing apparatus 200 creates the distortion adding table will be described below. However, an apparatus (computer) other than the image processing apparatus 200, specifically, a table creating apparatus may create the LUT 30. This table forming processing is performed before the inspecting method according to the flow chart illustrated in FIG. 3 is executed, and makes the HDD 204 store the formed LUT 30.

Firstly, the CPU 201 forms a distortion eliminating table (LUT) 40 of eliminating the distortion caused by the imaging lens 105A from the object image, based on the camera parameter of the camera 105, as is illustrated in FIG. 11 (S201). Hereafter, the distortion eliminating table is referred to as “distortion eliminating LUT” or “LUT”, except for “distortion eliminating table”.

The distortion eliminating LUT 40 has a plurality of table elements 41 each of which associates the coordinate position of the pixel at the start point of moving, with the moving distance of the pixel at the start point of moving with respect to the destination of moving. The reference character of the moving distance in the lens distortion eliminating LUT 40 is contrary to that at the same position in the distortion adding LUT 40X in FIG. 14, as is illustrated in FIG. 11, because distortion elimination is contrary to distortion addition.

Next, the CPU 201 determines a searching range for the pixel (noticed pixel) 41 which has been noticed (S202). The searching range is a range in which the pixel at the start point of moving possibly comes to the coordinate position of the noticed pixel. In the example of FIG. 11, the searching range 42 is a range of 3×3 pixels centering on the noticed pixel. The searching range 42 may be set at the value or less, which is the largest moving distance that can occur due to the distortion of the imaging lens 105A.

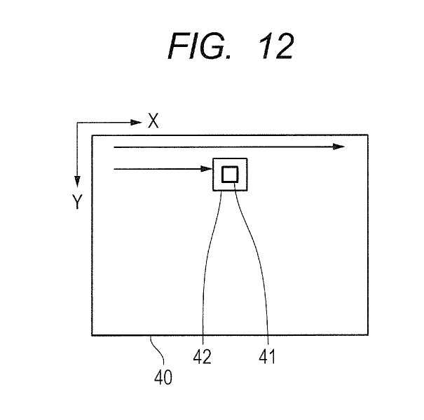

Next, the CPU 201 starts the scanning of the noticed pixel 41 from the upper leftmost pixel of the image (S203). FIG. 12 is an explanatory view illustrating a method for scanning the noticed pixel. The CPU 201 increases the noticed pixel 41 one by one in the X-axis direction of the distortion eliminating LUT 40, and shifts also the searching range 42 similarly along with the increase, as is illustrated in FIG. 12. When having scanned the rightmost end of the image, the CPU 201 lowers the scanning line by one pixel in the Y-axis, and scans the pixels again in the X-axis.

Next, the CPU 201 performs searching range scanning of searching the inside of the searching range 42 of the noticed pixel on the distortion eliminating LUT 40 (S204), and if there is the pixel (corresponding point) which comes to the coordinate position of the noticed pixel 41, the CPU 201 reverses the reference character and stores the resultant value (S205). Specifically, the CPU 201 proceeds the record of the moving distance of a pixel to which the distortion is added, reversely from the position of the pixel after a pixel which has been subjected to the distortion eliminating correction. For instance, the moving distances of the pixel which comes to the coordinate position that is noticed in FIG. 11 are (0, 0) and (+1, 0). Accordingly, the positive and negative reference characters are reversed, and the moving distances of (0, 0) and (−1, 0) are recorded in a form of being associated with the coordinate position of the noticed pixel, as a table element 31 of the distortion adding LUT 30.

As has been described above, each of the table elements 31 of the LUT 30 is formed in such a way that the moving distance of which the positive and negative reference characters of the moving distance of the pixel are reversed that has moved to the coordinate position which is noticed is associated with the coordinate position which is noticed, when the coordinate position of each of the pixels of the object image has been converted by the LUT 40.

The CPU 201 determines whether or not search for all of the corresponding points in the searching range of the noticed pixel has ended (S206). If the search has not ended (S206: No), the process returns to the step S204, and if the search has ended (S206: Yes), the process proceeds to the step S207.

The distortion eliminating LUT 40 is produced in a form of integers, and accordingly there exists also the case where there is no corresponding point which comes to the noticed pixel. In this case, the CPU 201 copes with the situation by holding a value in the vicinity of the noticed pixel (S207) or by other countermeasures. As one example, there is a method of holding a value in a pixel one left and one upper of the noticed pixel in the LUT 30 which has been already created.

The CPU 201 determines whether or not the above described search and record for all of the pixels of the distortion eliminating LUT 40 have ended (S208). If the search and the record have not ended (S208: No), the process returns to the step S203, and if the search and the record have ended (S208: Yes), the processing ends. Thereby, the distortion adding LUT 30 is completed.

As an example, the image was determined to have 2048×2048 pixels, the camera was determined to have a focal length of approximately 40 [mm], and the inspection object surface WA was determined to have a square shape of a 30×30 [mm] square. The processing speed were compared on the same PC condition between the case where the distortion was added to the image with the use of the LUT 30 in the present embodiment and the case where the distortion was added to the image with the use of the LUT 40X in combination with expansion contracting processing in the comparative example. A region calculating speed in the case where the LUT 30 in the present embodiment was used was 8 [ms], but the region calculating speed took the time period of 48 [ms] when the combination technique of the LUT 40X and the expansion contracting processing in the comparative example was used.

As has been described above, the inspecting apparatus according to the present embodiment can calculate the inspection region in consideration of the lens distortion, at a higher speed than other methods, by calculating the inspection region while using the LUT 30. In addition, the inspecting apparatus stores the LUT 30 in the HDD 204 beforehand, and calculates the inspection region by using the LUT 30 which is stored in the HDD 204, and accordingly can reduce the calculation load in the CPU 201.

Incidentally, the present invention is not limited to the above described embodiments, but can be variously modified within a range of the technical idea of the present invention. In addition, in regard to the effects which have been described in the embodiments of the present invention, the most suitable effects that are created by the present invention are merely enumerated, and the effects according to the present invention are not limited to the effects which have been described in the embodiments of the present invention.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-128700, filed Jun. 26, 2015, which is hereby incorporated by reference herein in its entirety.

What is claimed is:

1. An inspecting method in which a camera has an imaging device and an imaging lens, and a processing unit makes the camera pick up an image of a work and inspects the work based on the obtained image, comprising:
pixel calculating in which the processing unit specifies a three-dimensional model that corresponds to the work and a virtual surface that corresponds to the imaging device, projects the three-dimensional model in the same relative position as a relative position of the work at the time when the image has been picked up by the camera, onto the virtual surface, and calculates boundary pixels which constitute an outline of the projected region;
converting in which the processing unit converts a coordinate position of the boundary pixel, according to a distortion adding table that has a plurality of table elements each of which associates the coordinate position of the pixel at a start point of moving, with a moving distance of the pixel at the start point of moving with respect to a destination of moving, and adds distortion caused by the imaging lens to an object image;
setting in which the processing unit sets an inside surrounded by the boundary pixels of which the coordinate positions have been each converted in the converting, as an inspection region; and
inspecting in which the processing unit inspects the inside of the inspection region in the image, wherein
a plurality of table elements of the distortion adding table includes a first table element which associates one moving distance with one coordinate position so that a pixel at a start point of moving moves to one coordinate position, and a second table element which associates a plurality of moving distances with one coordinate position so that a pixel at the start point of moving dispersedly moves to a plurality of coordinate positions.

2. The inspecting method according to claim 1, wherein
a distortion eliminating table is formed that has the plurality of table elements each of which associates the coordinate position of the pixel at the start point of moving, with the moving distance of the pixel at the start point of moving with respect to the destination of moving, by eliminating the distortion caused by the imaging lens from the object image, based on a camera parameter of the camera; and
the distortion adding table is formed by associating the moving distance of which the positive and negative reference characters of the moving distance of the pixel are reversed that has moved to the coordinate position which is noticed, when the coordinate position of each of the pixels of the object image has been converted according to the distortion eliminating table, with the coordinate position which is noticed.

3. The inspecting method according to claim 1, wherein
the distortion adding table is stored in a storage unit beforehand, and in the converting, the processing unit converts a coordinate position of the boundary pixel according to the distortion adding table stored in the storage unit.

4. The inspecting method according to claim 1, further comprising image acquiring in which the processing unit changes a relative position of at least one of a light source and the camera, with respect to the work that has been irradiated with light of the light source, makes the camera pick up the image of the work, and acquires a plurality of the images.

5. The inspecting method according to claim 4, wherein
the work is an optical component, and in the inspecting, the processing unit extracts candidates of defect in the inspection region in each of the images, and inspects whether the candidates of the defect are defective or not.

6. An inspecting apparatus comprising:
a camera which has an imaging device and an imaging lens; and
a processing unit which makes the camera pick up an image of a work and inspects the work based on the obtained image, wherein
the processing unit executes:
pixel calculating processing of specifying a three-dimensional model that corresponds to the work and a virtual surface that corresponds to the imaging device, projecting the three-dimensional model in the same relative position as a relative position of the work at the time when the image has been picked up by the camera, onto the virtual surface, and calculating boundary pixels which constitute an outline of the projected region;
converting processing of converting a coordinate position of the boundary pixel, according to a distortion adding table that has a plurality of table elements each of which associates a coordinate position of the pixel at a start point of moving, with a moving distance of the pixel at the start point of moving with respect to a destination of moving, and adds distortion caused by the imaging lens to an object image;
setting processing of setting an inside surrounded by the boundary pixels of which the coordinate positions have been each converted in the converting processing, as an inspection region; and
inspecting processing of inspecting the inside of the inspection region in the image, wherein
the plurality of table elements of the distortion adding table includes a first table element which associates one moving distance with one coordinate position so that a pixel at a start point of moving moves to one coordinate position, and a second table element which associates a plurality of moving distances with one coordinate position so that the pixel at the start point of moving dispersedly moves to a plurality of coordinate positions.

7. The inspecting apparatus according to claim 6, wherein
the processing unit further executes table forming processing of forming the distortion adding table and storing the distortion adding table in a storage unit, and
in the converting processing, converts a coordinate position of the boundary pixel according to the distortion adding table which has been stored in the storage unit.

8. The inspecting apparatus according to claim 7, wherein
in the table forming processing,
the processing unit forms a distortion eliminating table that has the plurality of table elements which correspond to a plurality of pixels of the object images, respectively, and each of which associates the coordinate position of the pixel at the start point of moving, with the moving distance of the pixel at the start point of moving with respect to the destination of moving, and eliminates the distortion caused by the imaging lens from the object image, based on a camera parameter of the camera; and
creates the table element of the distortion adding table by associating the moving distance of which the positive and negative reference characters of the moving distance of the pixel are reversed that has moved to the coordinate position which is noticed, when the coordinate position of each of the pixels of the object image has been converted according to the distortion eliminating table, with the coordinate position which is noticed.

9. The inspecting apparatus according to claim 6, wherein
the work is an optical component, and in the inspecting processing, the processing unit extracts candidates of defect in the inspection region in each of the images, and inspects whether the candidates of the defect are defective or not.

10. The inspecting apparatus according to claim 6, further comprising a light source which irradiates the work with light, wherein
the processing unit further executes image acquiring processing of changing a relative position of at least one of the light source and the camera, with respect to the work, making the camera pick up an image of the work, and acquiring a plurality of the images.

11. An image processing apparatus comprising a processing unit which makes a camera having an imaging device and an imaging lens pick up an image of a work, and inspects the work based on the obtained image, wherein
the processing unit executes:
pixel calculating processing of specifying a three-dimensional model that corresponds to the work and a virtual surface that corresponds to the imaging device, projecting the three-dimensional model in the same relative position as a relative position of the work at the time when the image has been picked up by the camera, onto the virtual surface, and calculating boundary pixels which constitute an outline of the projected region;
converting processing of converting a coordinate position of the boundary pixel, according to a distortion adding table that has a plurality of table elements which correspond to a plurality of pixels of object images, respectively, and each of which associates a coordinate position of the pixel at a start point of moving, with a moving distance of the pixel at the start point of moving with respect to a destination of moving, and adds distortion caused by the imaging lens to an object image;
setting processing of setting an inside surrounded by the boundary pixels of which the coordinate positions have been each converted in the converting processing, as an inspection region; and
inspecting processing of inspecting the inside of the inspection region in the image, wherein
the plurality of table elements of the distortion adding table includes a first table element which associates one moving distance with one coordinate position so that a pixel at a start point of moving moves to one coordinate position, and a second table element which associates a plurality of moving distances with one coordinate position so that the pixel at the start point of moving dispersedly moves to a plurality of coordinate positions.

12. A non-transitory computer-readable recording medium storing a readable program for operating a computer to execute an inspecting method in which a camera has an imaging device and an imaging lens, and a processing unit makes the camera pick up an image of a work and inspects the work based on the obtained image, the inspecting method comprising:
pixel calculating in which the processing unit specifies a three-dimensional model that corresponds to the work and a virtual surface that corresponds to the imaging device, projects the three-dimensional model in the same relative position as a relative position of the work at the time when the image has been picked up by the camera, onto the virtual surface, and calculates boundary pixels which constitute an outline of the projected region;
converting in which the processing unit converts a coordinate position of the boundary pixel, according to a distortion adding table that has a plurality of table elements each of which associates the coordinate position of the pixel at a start point of moving, with a moving distance of the pixel at the start point of moving with respect to a destination of moving, and adds distortion caused by the imaging lens to an object image;
setting in which the processing unit sets an inside surrounded by the boundary pixels of which the coordinate positions have been each converted in the converting, as an inspection region; and
inspecting in which the processing unit inspects the inside of the inspection region in the image, wherein
a plurality of table elements of the distortion adding table includes a first table element which associates one moving distance with one coordinate position so that a pixel at a start point of moving moves to one coordinate position, and a second table element which associates a plurality of moving distances with one coordinate position so that a pixel at the start point of moving dispersedly moves to a plurality of coordinate positions.
